(19) United States
(12) Patent Application Publication
(10) Pub. No.: US 2022/0410297 A1
(43) Pub. Date: Dec. 29, 2022

(54) METHOD AND DEVICE FOR ELECTROCHEMICALLY TREATING COMPONENTS

(71) Applicant: MTU Aero Engines AG, München (DE)

(72) Inventors: Nicole Feiling, München (DE); Markus Zeis, München (DE); Roland Huttner, Jesenwang (DE); Christian Doll, Markt Indersdorf (DE)

(73) Assignee: MTU Aero Engines AG, München (DE)

(21) Appl. No.: 17/639,049

(22) PCT Filed: Aug. 13, 2020
(86) PCT No.: PCT/DE2020/000187

§ 371 Date: Sep. 2, 2022

(30) Foreign Application Priority Data
Sep. 3, 2019 (DE) 10 2019 213 342.8

(51) Int. Cl. B23H 3/10; B23H 3/04

(52) U.S. Cl. CPC B23H 3/10; B23H 3/04

(57) ABSTRACT

The invention relates to a device and a method for electrochemically treating a component, comprising at least one electrode which has at least one working surface with an outer contour that is shaped so as complement the surface of the component to be produced, thereby forming a gap, and comprising at least one contour surface which adjoins said working surface and in which at least one cleaning opening is arranged, a cleaning fluid flowing through said cleaning opening. According to the method, at least one component is provided, a voltage is applied between the component and the at least one electrode during the electrochemical treatment, and the electrode is moved relative to the component.

### BACKGROUND OF THE INVENTION

The invention relates to a method and a device for electrochemically treating a component, comprising at least one electrode which has at least one working surface with an outer contour that is shaped so as to complement the component surface to be produced, thereby forming a gap, and has at least one outer surface that adjoins said working surface.

In a method for electrochemical treatment (elysing) of a component, such as electrochemical machining (ECM: “electrochemical machining”) or precise electrochemical machining (PECM: “precise electrochemical machining”), an electrically conductive metal is abraded by way of an electrochemical process. In this case, a cathode (electrode, tool) is moved relative to an anode (component) and is thereby guided “into” or “through” the component. At the same time, an electrolyte is fed into the gap remaining between the cathode and the anode, said gap particularly also serving for removal of the process products thereby formed. Depending on the type of method employed, the feed rate is between 0.05 mm/min and 10 mm/min. The desired shape, defined in advance by the electrode, is thereby formed in the component.

In electrochemical treatment, adhesions, such as, for example, oxide residues or other conductive or nonconductive process residues, frequently remain behind on the treated surface of the component and have to be removed subsequently. When electrochemical machining is carried out, such process residues interfere with measurements that accompany the process or impede recording of the parameters of the component surface that has already been treated.

### SUMMARY OF THE INVENTION

Proceeding therefrom, an object of the present invention is to propose an improved method and a device for electrochemical treatment, which, in particular, enable the removal of adhesions or other process residues from the treated surface during the ongoing process. This is achieved in accordance with the present invention. Advantageous embodiments of the invention are discussed in detail below.

In order to achieve said object, in a first aspect, a method is proposed for electrochemically treating a component, comprising at least one electrode which has at least one working surface with an outer contour that is shaped so as to complement the component surface to be produced, thereby forming a gap. The at least one electrode in this case has at least one contour surface, which adjoins the outer contour of the working surface and in which at least one cleaning opening through which a cleaning fluid can flow is arranged. The method comprises the following method steps:
provision of the component;
application of a voltage between the component and the at least one electrode during electrochemical treatment of the component;
movement of the electrode relative to the component; and
feeding of a cleaning fluid under pressure through the at least one cleaning opening for the removal of adhesions, in particular nonconductive process residues, from the treated surface of the component.

The proposed method is carried out using at least one electrode, which has at least one working surface with an outer contour that is shaped so as to complement the component surface to be produced, thereby forming a gap, and has at least one contour surface that adjoins the outer contour of the working surface. In this case, the contour surface can extend essentially parallel to the direction of movement of the electrode opposite the component, but its cross section can also become larger and/or smaller relative to the contour surface gradually or stepwise, for example, or else can take on another desired shape, likewise gradually or stepwise, for example. In this contour surface, which, in particular, extends completely around the periphery or the contour line of the electrode, at least one cleaning opening through which a cleaning fluid can flow is arranged for carrying out the proposed method. The cleaning opening is arranged here at a suitable position so as to introduce the cleaning fluid directly into the region between the contour surface of the electrode and the already treated surface of the component.

In a first method step, the component, which, at least in the region of the intended treatment, is produced from an electrically conductive material and is to be treated, is provided and, in particular, is arranged in an appropriate position relative to the at least one electrode. In a further method step, a voltage is applied between the component and the at least one electrode during the electrochemical treatment of the component, in particular by an external voltage source, whereby the component is usually polarized as the anode (positive) and the electrode (tool) as the cathode (negative) in order to supply the flow of current required for a treatment.

In a further step, the electrode is moved along a path, in particular an intended path relative to the component, in order to carry out the treatment and/or in order to clean the treated surface of the component. For cleaning the treated surface, a cleaning fluid is fed under pressure through the at least one cleaning opening in order to remove adhesions, such as nonconductive process residues, in particular oxides, from the treated surface of the component mechanically as a result of a pressurized rinsing effect, in particular in the region of the cleaning opening or in the region lying opposite to the cleaning opening. In this case, the at least one cleaning opening is suitably formed and positioned in order to clean adhesions from at least one prespecified region of the surface of the component. In this case, the feeding of a cleaning fluid through the at least one cleaning opening and thus the cleaning of the component surface can occur, in particular, parallel to the electrochemical treatment at a delay in time relative to the treatment or else after conclusion of the electrochemical treatment of the component surface, such as, for example, in the course of retracting the electrode after the treatment. For example, the feeding of the cleaning fluid through the at least one cleaning opening and thus the cleaning of the component surface can occur at a delay in time after the start of the treatment, such as, for instance, when the cleaning openings are moved into the region of already produced openings. In this case, the feeding of the cleaning fluid through the at least one cleaning opening can be continued until, in the course of the electrode movement, the entire component surface produced has been cleaned.

In the proposed method, a cleaning of the surface produced during the treatment is also carried out by the electrode directly in conjunction with the treatment of the component. In this way, process residues, such as oxides in particular, can even be removed prior to a possible drying of the surface, without the necessity of using additional cleaning tools. The proposed method makes possible a high flow rate of the cleaning fluid on the surface produced. It is possible to use a mechanical rinsing effect resulting from this directly on the treated component surface in order to remove adhesions, such as, in particular, process residues, directly after the surface is produced. In this way, it is possible, even during the treatment of the component, for a (pre)cleaning of already produced surfaces to occur, so that the component is adequately clean even for measurements conducted parallel to the treatment, for example. In addition, the proposed method does not necessitate any additional device or devices for a (pre)cleaning of the surfaces produced.

One embodiment of the proposed method comprises the further step of recording at least one parameter of the treated surface of the component. For example, in particular, dimensions in regard to the shape and position of the produced component features as well as properties of the produced surface, such as, in particular, the surface quality or roughness thereof are recorded or measured in this case. By the measured values that can be obtained in this way directly after the treatment of a surface region, it is possible to adjust the treatment parameters during the ongoing process. Overall, on account of the possibilities of early intervention in the treatment process, the proposed method enables a higher precision and quality to be achieved during the treatment of components and, in particular, for example, even during quality control at an early time.

In one embodiment of the method for treating a component, the pressure and/or the volume flow of the cleaning fluid flowing through the at least one cleaning opening can be adjusted. Thus, it is possible to adjust the cleaning pressure of the cleaning fluid in accordance with the properties of adhesions, such as, for example, process residues, in particular in order to achieve a desired degree of cleaning. The adjustable pressure of the cleaning fluid in the exit region of the nozzle is here, for example, between 1 and 500 bar, in particular between 20 and 300 bar and in particular between 50 and 150 bar.

In one embodiment of the method, the cleaning fluid is accelerated as it flows through the cleaning opening. In particular, in this case, the at least one cleaning opening in the electrode is designed in such a way that it brings about an acceleration of the cleaning fluid. For this purpose, the cleaning opening has, for example, a constriction with a nozzle-like design, through which a cleaning fluid, which, in particular, is pressurized, accelerates when it flows through the cleaning opening. For example, an acceleration of this kind can also occur in a directionally dependent manner in order to adjust the cleaning effect of the jet of cleaning fluid also in a directionally dependent manner or to optimize it.

In a second aspect for achieving the object a device for electrochemically treating a component is proposed, by which, in particular, the method described in the preceding can be carried out. The device comprises at least one electrode, which has at least one working surface with an outer contour that is shaped so as to complement the component surface to be produced, thereby forming a gap. It is proposed that the electrode has a contour surface that adjoins the outer contour of the working surface and in which at least one cleaning opening through which a cleaning fluid can flow is arranged.

The at least one electrode of the device has at least one working surface with an outer contour that is formed with a gap so as to complement the component surface to be produced and has at least one contour surface that adjoins the outer contour of the working surface. As already explained above in regard to the proposed method, the contour surface here can extend essentially parallel to the direction of movement of the electrode relative to the component, although its cross section can also become larger and/or smaller gradually or stepwise, for example, with respect to the contour surface or else take on another desired shape, likewise gradually or stepwise, for example. Arranged in this contour surface is at least one cleaning opening through which a cleaning fluid can flow. The at least one cleaning opening is arranged here at a suitable position, so that a cleaning fluid, in particular a pressurized cleaning fluid, that flows through the cleaning opening can be introduced at a high flow rate directly into the region between the electrode and the already treated surface of the component.

With the aid of the proposed device, it is possible to utilize the electrode during or after the electrochemical treatment also as a cleaning tool in order to remove adhesions from the treated surface of the component. Owing to the positioning of the at least one cleaning opening in the contour surface, the jet action that is achievable by the high flow rate of the cleaning fluid on the treated component surface is directed so that adhesions there, such as, in particular, process residues, can be removed at an early time during the ongoing treatment of the component. Thus, it is possible even during the treatment of the component for a (pre)cleaning of the already produced surface regions to occur. Accordingly, for example, the component can also be cleaned adequately for parallel measurements or, in particular, for measurements occurring directly after the treatment. It is possible in this way to dispense with additional devices for a (pre)cleaning of the surfaces produced.

In one embodiment of the device, the contour surface has a plurality of cleaning openings through which a cleaning fluid can flow. In this case, the number of cleaning openings is chosen in such a way and they are arranged in such a way that the already treated region of the component or the component region to be cleaned is captured in a desired way by the jet action of the cleaning fluid flowing through the cleaning openings and the desired cleaning effect can be achieved. For example, the plurality of cleaning openings can be arranged, in particular, in a uniform distribution and/or in a prespecified pattern over the contour surface. It is equally possible that, in certain regions of the contour surface, more or fewer cleaning openings are arranged in accordance with, for example, a desired cleaning effect or in accordance with expected contaminants.

In one embodiment of the device, the at least one cleaning opening is designed in such a way that a cleaning fluid flowing through it is accelerated. By way of a suitable design of a cleaning opening, such as, for example, a nozzle-like design, that promotes, in particular, an acceleration of the cleaning fluid, in particular the pressurized cleaning fluid flowing through the cleaning opening, it is possible to adjust the properties of the jet of cleaning fluid to be advantageous for achieving a suitable cleaning effect and thereby, in particular, also to obtain a flow pattern that is advantageous for achieving the desired cleaning effect.

In one embodiment of the device, the electrode has at least one flow channel, through which the cleaning fluid can be fed to the at least one cleaning opening. In particular, the at least one flow channel of the electrode connects an inlet opening for the cleaning fluid to the at least one cleaning opening arranged in the contour surface. Depending on the number and arrangement of cleaning openings on the contour surface, it is also possible for the electrode to have a plurality of flow channels. In addition, it is also possible for a plurality of cleaning openings to be supplied by a single channel connected to each of them, whereby the flow channel can be connected to, for example, a supply chamber or can itself constitute a supply chamber.

In one embodiment of the device, the cleaning fluid is an electrolyte or another suitable fluid. Depending on the flow direction of the electrolyte in relation to the electrochemical treatment of the component and on the arrangement of the cleaning openings, it may be advantageous to utilize electrolyte fluid also as a cleaning fluid for the electrochemical treatment, for example, in order to prevent any mixing of electrolyte and another cleaning fluid in the region of the treatment. In one embodiment, the electrolyte is therefore utilized not only for its conventional function in an electrochemical treatment method, but also as a cleaning fluid.

Alternatively, however, it is also possible to utilize any other suitable fluid as a cleaning fluid, in particular mixing of the electrolyte utilized for the treatment with the cleaning fluid is avoidable or non-detrimental owing to, in particular, the method or the arrangement. As a cleaning fluid, it is possible here to use any suitable fluid, such as, for example, even water. The latter can be used in pure form, for example. In another embodiment, in particular, it is also possible to add substances that support the cleaning function and may also have electrically conductive properties, for example, to water that is used as a cleaning fluid.

In one embodiment of the device, the cleaning fluid is fed by way of a separate supply circuit. In particular, when an electrolyte is used as a cleaning fluid, the feeding thereof can have a separate electrolyte supply circuit, as a result of which the electrolyte supply of the electrochemical treatment operation and the electrolyte supply of the cleaning function are each designed with separate supply circuits so as to be independent of each other.

In one embodiment of the device, the electrode has at least a two-part design, whereby, on at least one first part, the working surface is arranged and, on at least one second part, at least one section of the contour surface is arranged. It is advantageous in an at least two-part design of the electrode, for example, to be able to produce the electrode from different materials and/or to fabricate the inner contour from at least one parting surface.

In one embodiment of the device, the at least one second part is formed from, in particular, an electrically nonconductive material. Thus, for example, the first part, on which the working surface is arranged, can be produced from an electrically conductive material that makes possible the electrochemical treatment. In this case, the second part of the electrode, on which at least one section of the contour surface with at least one cleaning opening is arranged, can be produced from an electrically nonconductive material, such as, for example, from a nonferrous metal or a plastic. This is advantageous particularly in the case when no further, and particularly undesired, electrochemical treatment of the component is to take place even in the case of a small gap between the component and the electrode in this region.

In one embodiment of the device, the electrode is produced at least in part by an additive manufacturing method. An additive manufacturing method makes possible, in particular, an advantageous production of inner contours that offers many degrees of freedom, in particular, in the present instance, of flow channels for a cleaning fluid, as well as for the shaping of the at least one cleaning opening arranged in the contour surface.

In one embodiment, the device has a control device, which, in particular, makes it possible to adjust the pressure and/or the flow rate of the cleaning fluid through the at least one cleaning opening. In this way, the cleaning effect of the jet of cleaning fluid on the treated surface or the effect thereof on the properties of adhesions present there can be adjusted and, in particular, this adjustment can be made during the ongoing process and in interaction with a recording of the surface properties produced after the cleaning of the surface.

### BRIEF DESCRIPTION OF THE DRAWING FIGURES

Further features, advantages, and possible applications of the invention ensue from the following description in association with the figures. Shown are:

FIG. 1: a schematic three-dimensional illustration of an exemplary device according to the invention for electrochemically treating a component;

FIG. 2: a schematic illustration of another exemplary device according to the invention for electrochemically treating a component in a sectional illustration; and

FIG. 3: a schematic illustration of a flow chart of the method according to the invention.

### DESCRIPTION OF THE INVENTION

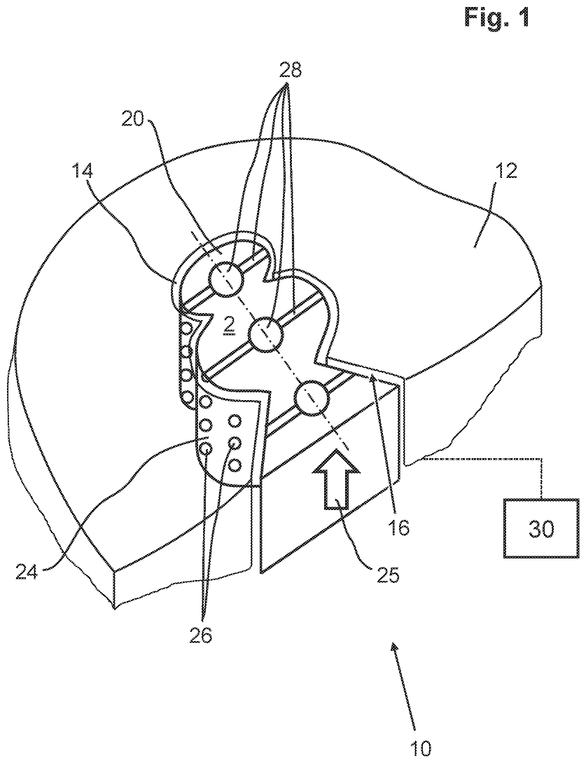

FIG. 1 shows a schematic three-dimensional illustration of an exemplary device 10 according to the invention for electrochemically treating a component 12 (illustrated transparently), which, in the exemplary embodiment, is designed as a rotor blade of a turbomachine. The device 10 has an electrode 20, the direction of movement of which, 25, is indicated by an arrow. The working surface 21 of the electrode 20, which, in the exemplary embodiment, is provided for producing a fir tree profile groove, lies above the plane of the section in the illustration in FIG. 1 and is therefore not shown.

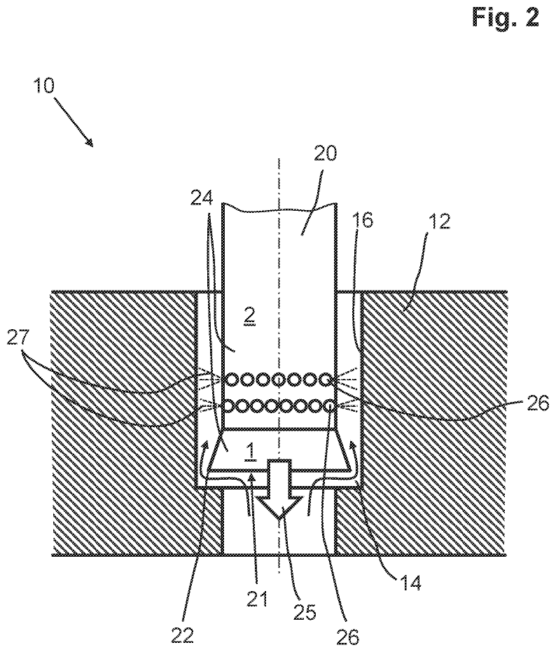

Shown in FIG. 1 is a section of the contour surface 24 that adjoins the outer contour 22 (lying above the plane of section) of the working surface 21 of the electrode 20 and in which a plurality of cleaning openings 26 through which a cleaning fluid can flow are arranged. The contour surface 24 is shaped so as to complement the treated surface 16 of the component 12, thereby forming a gap 14. As the cleaning fluid that is fed through the at least one cleaning opening 26 flows through the cleaning opening 26, it forms a cleaning fluid jet 27 (shown in FIG. 2), which is directed at the treated surface 16 and by which adhesions, such as, in particular, oxide residues, can be detached from the treated surface 16. For feeding of the cleaning fluid to the cleaning openings 26, a plurality of flow channels 28 are arranged in the electrode 20, through which the cleaning fluid can be fed to the respective cleaning openings 26.

The second part 2 of the exemplary electrode 20 shown in FIG. 1 is produced from, in particular, an electrically nonconductive material, such as, for example, a nonferrous metal or a plastic. Thus, it is possible to avoid a further electrochemical treatment of the component 12 in the region of the second part of the electrode 20. The electrode 20 can be produced at least in part by an additive manufacturing method, as a result of which complex outer and inner designs of, for example, the cleaning openings 26 or the flow channels 28 for the feeding of the cleaning fluid can be produced. Furthermore, the device 10 illustrated in FIG. 1 has a control device 30, which, in particular, makes it possible to adjust the pressure and/or the flow rate of the cleaning fluid through the at least one cleaning opening 26.

FIG. 2 shows a schematic illustration of another exemplary device 10 according to the invention for electrochemically treating a component 12. The device has at least one electrode 20 with a working surface 21. The working surface 21 has an outer contour 22, which is shaped so as to complement the surface 16 of the component 12 that is to be produced and then treated, thereby forming a gap 14. Adjoining the outer contour 22 of the working surface 21 of the electrode 20 is a contour surface 24, in which at least one cleaning opening 26 through which a cleaning fluid can flow is arranged. In FIG. 2, for example, two rows and thus a plurality of cleaning openings 26 are illustrated. The number and arrangement of the cleaning openings 26 depend, in particular, on the treatment parameters and on the desired cleaning result. Also illustrated in FIG. 2 by way of an arrow is the direction of movement 25 of the electrode 20 as well as, by two arrows arranged in the gap 14, the flow direction of the electrolyte required for electrochemically treating the component 12.

The cleaning fluid fed through the at least one cleaning opening 26 is usually pressurized and/or the at least one cleaning opening 26 is designed in such a way that the cleaning fluid is accelerated when it flows through the cleaning opening 26. A flow through the cleaning opening 26 results in the creation of a fluid jet 27 that is directed at the treated surface 16 and by which adhesions, such as, in particular, process residues, can be detached from the treated surface 16. For feeding of the cleaning fluid to the at least one cleaning opening 26, at least one flow channel (not illustrated in FIG. 2) is arranged in the electrode, through which the cleaning fluid can be fed to the respective cleaning opening 26.

The exemplary electrode illustrated in FIG. 2 is designed in two parts. In this case, the working surface 21 is arranged on a first part 1. In the illustrated exemplary electrode 20, the contour surface 24 that adjoins the outer contour 22 of the working surface 21 is arranged by section on the first part 1 and on the second part 2 of the electrode 20, with the cleaning openings 26 in the exemplary embodiment being arranged only in the region of the section of the contour surface 24 that is arranged on the second part 2 of the electrode 20. The electrode 20 can be produced in this case at least in part by an additive manufacturing method, as a result of which the production of complex electrode geometries and/or specific shapes of nozzle-like cleaning openings 26 is (are) simplified.

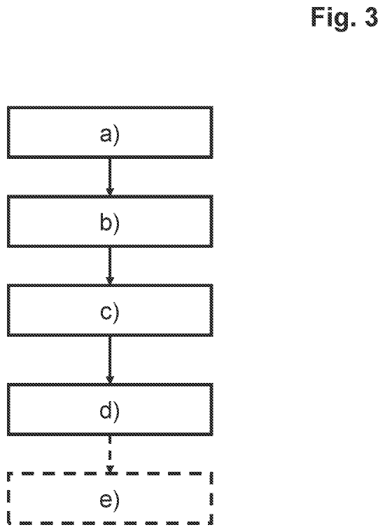

FIG. 3 shows a schematic illustration of a flow chart of the method according to the invention for electrochemically treating a component 12, comprising at least one electrode 20. In this case, the electrode 20 has at least one working surface 21 with an outer contour 22, which is shaped with the formation of a gap 14 so as to complement the surface 16 of the component 12 to be produced. Furthermore, the electrode 20 has at least one contour surface 24 that adjoins said working surface and in which at least one cleaning opening through which a cleaning fluid can flow 26 is arranged.

The method according to the invention comprises the following steps: In a first step a), the component 12 is provided. In the second step b), during the electrochemical treatment of the component 12, a voltage is applied between the component 12 and the at least one electrode 20. Subsequently, in the third step c), the electrode 20 is moved with respect to the component 12 and in this way, in particular, the intended treatment and/or the cleaning of the produced surface is or are carried out. In the step d), a pressurized cleaning fluid is fed through the at least one cleaning opening 26 in order to remove, by way of the cleaning fluid jet 27 that is thereby formed, adhesions, in particular nonconductive process residues, from the treated surface 16 of the component 12. In an optional further step e), at least one parameter of the treated surface 16 of the component 12 is recorded in order to carry out, for example, a quality control and/or in order to adjust the treatment parameters.

1. A method for electrochemically treating a component, comprising at least one electrode, which has at least one working surface with an outer contour that is shaped to complement the surface of the component to be produced, thereby forming a gap, and comprising at least one contour surface that adjoins said working surface, and in which at least one cleaning opening PO through which a cleaning fluid can flow is arranged, comprising the method steps of:
providing the component;
applying a voltage between the component and the at least one electrode during the electrochemical treatment of the component;
moving the electrode PO relative to the component; and
feeding of a cleaning fluid under pressure through the at least one cleaning opening for the removal of adhesions, in the form of nonconductive process residues, from the treated surface of the component.

2. The method treating a component according to claim 1, further comprising the step of:
recording at least one parameter of the treated surface of the component.

3. The method for treating a component according to claim 1, wherein the pressure and/or the flow rate of the cleaning fluid flowing through the at least one cleaning opening can be adjusted.

4. The method for treating a component according to claim 1, wherein, when the cleaning fluid flows through the cleaning opening, it is accelerated.

5. A device for electrochemically treating a component, by the method according to claim 1, comprising at least one electrode, which has at least one working surface with an outer contour that is shaped to complement the surface of the component to be produced, thereby forming a gap, wherein a contour surface that adjoins the outer contour of the working surface, and in which at least one cleaning opening through which a cleaning fluid can flow is arranged.

6. The device for electrochemically treating a component according to claim 5, wherein the contour surface has a plurality of cleaning openings through which a cleaning fluid can flow.

7. The device for electrochemically treating a component according to claim 5, wherein the at least one cleaning opening is configured and arranged so that a cleaning fluid flowing through it is accelerated.

8. The device for electrochemically treating a component according to claim 5, wherein the electrode has at least one flow channel, through which the cleaning fluid can be fed to the at least one cleaning opening.

9. The device for electrochemically treating a component according to claim 5, wherein the cleaning fluid is an electrolyte or another suitable fluid.

10. The device for electrochemically treating a component according to claim 5, wherein the feeding of the cleaning fluid occurs via a separate supply circuit.

11. The device for electrochemically treating a component according to claim 5, wherein the electrode is configured and arranged in at least two parts, wherein the working surface is arranged on at least one first part and at least one section of the contour surface is arranged on at least one second part.

12. The device for electrochemically treating a component according to claim 11, wherein the at least one second part configured and arranged as an electrically nonconductive material.

13. The device for electrochemically treating a component according to claim 5, wherein the electrode is produced at least in part by an additive manufacturing method.

14. The device for electrochemically treating a component according to claim 5, further comprising a control device, which is configured and arranged to adjust the pressure and/or the flow rate of the cleaning fluid through the at least one cleaning opening.
